(19) United States
(12) Patent Application Publication
(10) Pub. No.: US 2008/0068673 A1
(43) Pub. Date: Mar. 20, 2008

(54) DIGITAL IMAGE INFORMATION SYSTEM AND METHOD FOR PROVIDING AN IMAGE OBJECT IN A DIGITAL IMAGE INFORMATION SYSTEM

(76) Inventors: Steinar Kolbu, Erlangen (DE); Dirk Sunderbrink, Baiersdorf (DE)

Correspondence Address: SCHIFF HARDIN, LLP;PATENT DEPARTMENT, 6600 SEARS TOWER, CHICAGO, IL, 60606-6473, US

(21) Appl. No.: 11/851,598

(22) Filed: Sep. 7, 2007

(30) Foreign Application Priority Data
Sep. 14, 2006 (DE) 10 2006 043 171.5

(51) Int. Cl. H04N 1/024

(52) U.S. Cl. 358/472

(57) ABSTRACT

In a method and system for provision of image objects in a digital image information system controlled by an electronic data management device, with a first long term data storage device for archiving of pixel portions of the image objects in a first data format and a second long term data storage device in which are archived pixel portions of the image objects in a second data format differing from the first data format, and a databank associated with the two long term data storage devices, text portions of image objects stored in the two long term data storage devices are stored in a first data format in the data bank. The text portion of the queried image object is read from the databank on the basis of an image object query, and using the text portion it is determined whether the pixel portion of the queried image object is stored in the first long term data storage device or in the second long term data storage device. If the pixel portion of the queried image object is stored in the first long term data storage device, the pixel portion of the queried image object is read from the first long term data storage device and the queried image object is subsequently provided. If the pixel portion of the queried image object is stored in the second long term data storage device, the pixel portion of the queried image object is read from the second long term data storage device, is converted from the second data format into the first data and the queried image object is subsequently provided.

### BACKGROUND OF THE INVENTION

1. Field of the Invention

The invention in the field of digital image information systems and concerns a method for providing an image object in an image information system administered by an electronic data management device, a digital image information system suitable for implementation of the method; a data management device of the digital image information system, a machine-readable program code that contains control commands that prompt the data management device to implement the inventive method, and a storage medium for the program code.

2. Description of the Prior Art

Medical image information systems for image object administration, meaning for storage, archiving and provision of medical image subjects, are increasingly used in clinics and doctors' practices. PACS systems (PACS=Picture Archiving and Communications System) used originally purely for the purposes of image data administration are typically merged today with administratively oriented information systems (such as, for example, radiology information systems (RIS) or hospital information systems (HIS)) into integrated image information systems.

In such digital image information systems, imaging modalities (such as, for example, computed tomography systems, magnetic resonance tomography systems, positron emission tomography systems, angiography system and sonography systems) generate medical images in the form of pixel data that are sent via a communication network to an image storage and archiving system and there are stored and archived together with administrative text data such as, for example, patient name, birth date, patient number, apparatus number, examination date, study number, etc. The text data are conventionally stored in a databank associated with the long term data storage device for archiving of the pixel data of image objects. An identifier for identification and association of archived and stored pixel data regarding an image object is always contained in the text data.

The pixel data of generated image objects are typically initially stored in a short term data storage, for example a non-volatile memory with a number of coupled fixed discs (what is known as a RAID storage (RAID=Redundant Array of Independent Disks). From there the data can be queried from image workstations within a short time (for example within a few seconds) for assessment and/or consideration and/or processing.

The pixel data of the image objects are subsequently transferred into a long term data storage for permanent archiving after the expiration of a selectable time span (such as, for example, 6 to 12 months) or, for example, after assessment. The long term data storage can be, for example, a unit known as a jukebox with a number of tape storage or magneto-optical or optical discs such as CDs (Compact Discs) or DVDs (Digital Versatile Discs). Due to legal rules it is required that the image data must be retained and presentable for a longer span of time of, for example, 10 to 30 years.

Image objects in a medical image information system are stored in a data format that is selectable by the manufacturers. Since various components of a medical image information system are often produced by various manufacturers, for harmonization of various data formats an open standard (DICOM=Digital Imaging and Communication) was created in cooperation with the American College of Radiology and the National Electrical Manufacturers Association. This standard establishes (among other things) the structure of the data formats and the descriptive parameters for radiological images, the commands for exchanging these images and the description of other data objects such as image sequences, examination series and findings. According to DICOM an image object contains: a header portion (text data portion) in which containing administrative information such as patient name, birth date, patient number and the like; and a pixel portion (pixel data) containing the pixel-based image content of the image acquired by an imaging modality.

Image information systems for storage and archiving of medical images have now been commercially marketed since the early '80s and have also been used since this time in larger clinics. In the course of the technological development, the image information systems were continually improved, by systems components (data storage) and system properties (such as data formats for storage of image objects and transfer protocols for communication between components of the image information system) being changed or improved by the manufacturers.

As a result, upon new installation of an image information system users of older image information systems are frequently confronted with the problem of how a data transfer is to be effected when the new image information system to be installed uses a data format for storage of image objects that is different than the data format from the previously used image information system.

This problem was previously solved by installing only image information systems having a data format compatible with the data format of the older image information system, such that the previous image archive (long term data storage) can be accessed. However, this requires that a new system with “matching” data format even be available, and has the disadvantage that the user of an older image information system is limited in the selection of the new image information system. Alternatively, a complete data transfer can be implemented, with which the image objects of the older image information system are converted into the data format of the new image information system and stored there after transfer using an open standard (such as, for example, DICOM). Such a procedure requires that the older image information system have a suitable interface for transferring the data and requires a very long time span of, for example, multiple years due to the high amount of incoming data, typically of at least several terabytes. Such a complete data transfer is additionally very costly since storage media for storage of the image objects archived in the older system must be provided and the image objects are available again only after a complete data transfer. Thus the user is forced (due to the legal requirement of presentation capability of archived image objects) to continue to operate the old image information system for a certain transfer time span until the conclusion of the complete data migration. Furthermore, the performance of the newly installed image information system can be impaired due to the high amount of incoming data.

### SUMMARY OF THE INVENTION

An object of the present invention is to provide a method for storing image objects in a medical image information system with which the aforementioned problems and disadvantages incurred with a changing of the data format for data storage devices for archiving of image data can be avoided.

According to the invention this object is achieved by a method for provision of image objects in a digital image information system administered (controlled) by an electronic data management device. The digital image information system has an image archiving and storage system for archiving and storage of text and pixel portions of image objects in a first data format.

As used herein “image object” means data which, as explained in the preceding, include a text portion containing administrative information and a pixel portion containing the pure image data. An identifier (key) associated with the pixel portion is contained in the text portion for identification of the pixel data of an image object. The identifier can be part of the administrative information or can be newly generated. The image objects can each be one image or a number (for example a sequence) of images generated by an imaging modality. The image objects can be images that were generated by a number of imaging modalities.

In the inventive image information system the image archiving and storage system for archiving, and storage of text portions and pixel portions of image objects in a first data format includes a non-volatile first long term data storage device (administered by a first electronic storage management device) for archiving of the pixel portions of image objects in a first data format and a databank (associated with the first long term data storage device) for storage of the text portions of the image objects in the first data format. The first electronic storage management device of the first long term data storage device, which can be part of the data management device of the image information system, is coupled with the data management device and is hierarchically subordinate to it.

The inventive image information system furthermore has a non-volatile second long term data storage device administered from a second electronic storage management device, in which second long term data storage device pixel portions of image objects are (already) archived in a second data format. The text portions of the image objects whose pixel portions are archived in the second long term data storage device are stored in the databank of the image archiving and storage system of the digital image information system. For this purpose, it is necessary that the text portions of image objects whose pixel portions are stored in the second long term data storage device (which pixel portions were originally stored in a second data format in a databank associated with the second long term data storage device, but such a databank is no longer present in the inventive image information system) are converted into the first data format and are transferred into the databank of the digital image information system. The second electronic storage management device for administration of the second long term data storage device (which can be part of the data management device of the image information system) is coupled with the data management device of the image information system and hierarchically subordinate thereto. The data management device of the image information system is inasmuch hierarchically superordinate to both the first storage management device for administration of the first long term data storage device and the second storage management device for administration of the second long term data storage device.

The second long term data storage device as well as the second storage management device for the administration thereof typically originate from a different (for example an older) image information system (PACS system), such that a newer archiving (in the first or second long term data storage device) of image objects in the second data format is not provided and only image objects already archived (in the second long term data storage device) should be read and provided.

The first long term data storage device and the second long term data storage device of the digital image information system serve for the archiving of image objects, for example over a time span of 10 to 30 years. For this purpose the first long term data storage device and the second long term data storage device are executed as non-volatile data stores, for example in the form of a RAID fixed disk storage, as a tape or disk storage, in particular as a jukebox with a plurality of magneto-optical or optical discs such as CDs or DVDs.

The first long term data storage device and the second long term data storage device can be (physically) separate stores. It is similarly possible fort the first long term data storage device and the second long term data storage device to be merely logically separated regions of (physically) the same storage.

As mentioned above, it is a requirement of the inventive method that initially all text portions of image objects whose pixel portions are stored in the second long term data storage device (which text portions exist in a second data format in a databank associated with the second long term data storage device) are converted into the first data format of the image information system and are stored in converted form in the databank of the digital image information system. This databank is then associated with the first long term data storage device and the second long term data storage device.

In the inventive method an image object query can be sent, for example, from an image workstation for assessment and/or consideration and/or processing of image objects (for example due to a manual interaction by a user) or can be generated automatically, for example from the electronic data management device of the image information system which executes steps described below.

First, as controlled by the electronic data management device of the image information system using a suitable attribute of the text portion of the queried image object (for example acquisition date) it is registered whether the pixel portion of the queried image object is stored in the first long term data storage device or in the second long term data storage device.

The registering of whether the pixel portion of the queried image object is stored in the first long term data storage device or in the second long term data storage device ensues via the electronic data management device. For this purpose, the data management device can be provided with a data storage registration and pixel portion request device (in particular executed in the form of a module) for registering of the data storage of the pixel portion of a queried image object and for requisitioning thereof.

For the case that the pixel portion of the queried image object is stored in the first long term data storage device, the pixel portion of the queried image object is read from the first long term data storage device (controlled by the data management device in cooperation with the first storage management device) and the queried image object is provided for consideration and/or assessment and/or processing.

For the case that the pixel portion of the queried image object is stored in the second long term data storage device, the pixel portion of the queried image object is read from the second long term data storage device (controlled by the data management device in cooperation with the second storage management device) and converted (from the second data format) into the first data format. The queried image object is then provided for consideration and/or assessment and/or processing.

The conversion of the pixel portion of the queried image object in the first image format ensues via the electronic data management device which for this purpose can be provided with an electronic data format conversion device (in particular executed in the form of a module) for conversion of the data format of pixel portions of image objects present in the second data format into the first data format.

A provision for consideration and/or assessment and/or processing of an image object stored in the first long term data storage device or in the second long term data storage device of the digital image information system can ensue, for example, by the image object being transferred (controlled by the data management device of the image information system) to an image workstation where it is stored in a local data storage device.

It is similarly possible for the image object to be stored in a short term data storage device of the digital image information system, for example in the framework of what is known as a “pre-fetch”. The short term data storage device serves for the storage of image data (pixel portions) of image objects to be shown and/or to be assessed and/or to be processed for a comparably short time span of, for example, 6 to 12 months. For a pre-fetch the image data are transferred from the first or second long term data storage device into the short term data storage device in advance for a selectable term. The short term data storage device of the image information system can in particular feature a faster access time (for example of a few seconds) in comparison to the first long term data storage device and the second long term data storage device. The short term data storage device is, for example, implemented as a RAID fixed disk storage in the image information system.

In the event that the pixel portion of the queried image object is stored in the short term data storage device, this is erased from the short term data storage device after a selectable time span (for example after the expiration of 6 to 12 months. In the event that the pixel portion of the queried image object is archived in the second long term data storage device, it can be advantageous when the pixel portion of the appertaining image object is stored (in the first data format) in the first long term data storage device, in particular after expiration of a selectable time span. In the latter case the pixel portion of the appertaining image object can additionally be erased from the second long term data storage device.

The invention also includes to an electronic data management device of a digital image information system which is provided with a machine-readable program code (computer program) that includes control commands that prompt the data management device to implement the inventive method described above.

Furthermore, the invention includes a machine-readable program code (computer program) for the electronic data management device of a digital image information system, which program code includes control commands that prompt the data management device to implement the inventive method described above.

Moreover, the invention includes a storage medium (computer program product) with a machine-readable program code stored therein for an electronic data management device of a digital image information system, the program code containing control commands that prompt the data management device to implement the inventive method described above.

According to the invention, a time-intensive and cost-intensive migration of all image data (pixel portions of image objects) of the second long term data storage device (which can be the image archive of an older image information system) is avoided in an advantageous manner by the conversion of image objects on the fly and as needed (corresponding to an image object query) from the second data format into the first data format. Since the image data can remain stored in the second long term data storage device, no additional non-volatile storage media must be retained. The performance of the image information system is not impaired by a conversion of only the queried image objects.

In the inventive method a conversion of image objects from a second data format (in particular a proprietary data format) into a first data format (in particular a proprietary data format) differing from the second data format is enabled without an interface for transfer of image objects between the two long term data storage devices with the aid of an open standard having to be used. The image objects whose pixel portion is stored in the second long term data storage device can be accessed quickly due to the possibility of caching in a short term data storage device.

### BRIEF DESCRIPTION OF THE DRAWINGS

The FIGURE shows in a schematic representation the design of an exemplary embodiment of the inventive digital image information system.

### DESCRIPTION OF THE PREFERRED EMBODIMENTS

An exemplary embodiment of the inventive image information system (medical system architecture) which is designated overall with the reference number 1 accordingly comprises components which can be associated with a first (newer) PACS system 2 and components which can be considered as remaining components of a second (older) PACS system 3, as well as an image workstation 4 for assessment and/or consideration and/or storage of image objects.

The remaining components of the older PACS system are: a second long term data storage device 9 in which pixel portions of image objects are archived in a proprietary second data format which, for example, is executed as a tape storage or as a disk storage, in particular as a jukebox with a number of magneto-optical or optical discs (such as CDs or DVDs); as well as a storage manager 10 for administration of the second long term data storage device 9, which storage manager 10 is part of a superordinate data management of the image information system 1, or is coupled with the data management of the digital image information system 1. Via the storage manager 10 the superordinate data management in particular is “informed” as to which storage location pixel portions of image objects are stored within the second long term data storage device 9.

A first long term data storage device 5 for archiving of pixel portions of image objects in proprietary first data format differing from the proprietary second data format is comprised in the newer PACS system 2, which first long term data storage device 5 is, for example, executed as a tape storage or as a disk storage, in particular as a jukebox with a number of magneto-optical or optical disks such as CDs or DVDs. It also comprises a short term data storage device 6 for short term storage of image objects or, respectively, of pixel portions of image objects, which short term data storage device 6 is, for example, executed as a RAID fixed disk storage. The long term data storage device 5 and the short term data storage device 6 are administered by a storage manager 8, which is part of a superordinate data management of the image information system 1 or is coupled with the data management. Via the storage manager 8 the superordinate data management in particular is informed about at which storage locations pixel portions of image objects are stored within the first long term data storage device 5.

Furthermore, the newer PACS system 2 has a databank 7 associated with the first long term data storage device 5 and the second long term data storage device 9, in which databank 7 are stored in a proprietary first data format text portions of pixel portions of image objects stored in the first long term data storage device 5 and in the second long term data storage device 9. For this purpose, it is necessary for text portions of image objects whose pixel portions to be stored in the second long term data storage device 9, which text portions were originally stored in a second proprietary data format in a databank associated with the second long term data storage device 9 (which databank is no longer comprised in the inventive image information system), are converted into the first proprietary data format and transferred to the databank 7 of the newer PACS system 2. Identifiers for identification of associated pixel portions of image objects are included in the text portions of image objects stored in the databank 7.

Also included in the new PACS system 2 as part of the superordinate data management are: a data storage registration and pixel portion request module 11 for registration of the long term data storage device of the pixel portion of a queried image object and to request the pixel portion of the image object; as well as a data format conversion module 12 for conversion of the data format of pixel portions of image objects present in the second data format in the second long term data storage device 9 into the first data format.

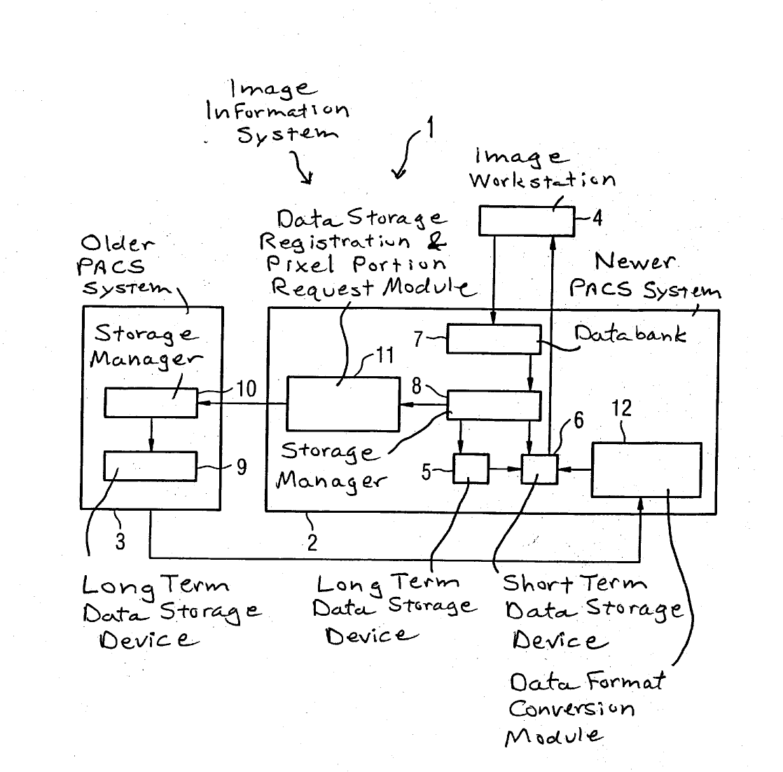

Although the first long term data storage device 5 and the second long term data storage device 9 are shown in FIG. 1 as data stores separate from one another, this should not preclude that the first long term data storage device 5 and the second long term data storage device 9 are formed by logically separated regions of (physically) the same data store.

The description of an exemplary embodiment of the inventive method now ensues:

After text portions of image objects whose pixel portions are stored in the second long term data storage device 9, which text portions were originally stored in a second proprietary data format in a databank associated with the second long term data storage device 9, have been converted into the first proprietary data format and have been transferred to the databank 7 of the newer PACS system 2, a transfer of pixel portions of (only) the queried image object ensues on the basis of image object queries which can be sent from the image workstation 4 (for example as a result of a manual interaction) or can be generated automatically.

More precisely, given each image object query if the image workstation 4 the data storage registration and pixel portion request module 11 checks whether the pixel portion belonging to the queried image object is stored in the first long term data storage device 5 or in the second long term data storage device 9 of the image information system 1. For this what is known as a “push model” or what is known as a “pull model” is possible.

To check this query, the data storage registration and pixel portion request module 11 reads the data attribute (text portion of the image objects) which are stored in the databank 7. Suitable attributes such as the examination date or a generated identifier can hereby be drawn upon for differentiation of whether the pixel portion belonging to the queried image object is stored in the first long term data storage device 5 or in the second long term data storage device 9.

For the case that the pixel portion belonging to the queried image object is stored in the first long term data storage device 5, the pixel portion is read from the first long term data storage device 5 and stored in the short term data storage device 6, from where it can be transferred (together with the associated text portion of the image object) within a very short time (for example within a few seconds) to the image workstation 4 for assessment and/or consideration and/or processing.

For the case that the pixel portion belonging to the queried image object is stored in the second long term data storage device 9, the pixel portion is read from the second long term data storage device 9, converted into the first data format by the data conversion module 12, and stored in converted form in the short term data storage device 6. From there it can be transferred (together with the associated text portion of the image object) within a very short time (for example within a few seconds) to the image workstation 4 for assessment and/or consideration and/or processing.

After the examination and/or assessment and/or processing of the image object, the pixel portion of the queried image object stored in the short term data storage device 6 is erased. The pixel portion of the queried image object can remain in unchanged (second) data format in the second long term data storage device 9. The pixel portion of the queried image object can additionally be archived in the first data format in the first long term data storage device 5. New image objects are only archived in the first data format in the first long term data storage device 5.

The image object query transferred to the databank is illustrated in FIG. 1 by an arrow directed from the image workstation 4 to the databank 7. The transfer of the text portion of the queried image object is illustrated by an arrow directed from the databank 7 to the first storage manager 8. The archiving of new image data in the first data format is illustrated by an arrow directed from the storage manager 8 to the first long term data storage device 5. The transfer of pixel portions of image objects present in the first data format in the first long term data storage device 5 into the short term data storage device 6 is illustrated by an arrow directed from the first long term data storage device 5 to the short term data storage device 6. The querying of the pixel portion of a queried image object stored in the second long term data storage device 9 is illustrated by an arrow directed from the data storage registration and pixel portion request module 11 to the second storage manager 10. Finally, the transfer of a pixel portion of the queried image object, which pixel portion is converted into the first data format, is illustrated by an arrow directed from the data format conversion module 12 to the short term data storage device 6.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for providing image objects in a digital information system having a first long term storage device, a second long term storage device and a data bank having access to each of said first and second long term storage devices, said method comprising the steps of:
archiving pixel portions of first image objects in a first image data format in said first long term storage device;
archiving pixel portions of second image objects in a second data format, differing from said first data format, in said second long term storage device;
storing text portions of said first image objects and said second image objects in said data bank;
upon an image object query to said data bank for a queried image object, reading the text portion of the queried image object from said data bank and, from said text portion, automatically determining whether the pixel portion of the queried image object is stored in said first long term data storage device or in said second long term data storage device;
if said pixel portion of the queried image object is stored in the first long term data storage device, reading the pixel portion of the queried image object from the first long term storage device, and making the text portion and the pixel portion of the queried image object available as an output; and
if said pixel portion of the queried image object is stored in said second long term data storage device, reading the pixel portion of the queried image object from the second long term data storage device, and automatically converting said pixel portion of the queried image object from said second data format into said first data format, and making the text portion and the converted pixel portion of the queried image object available as an output.

2. A method as claimed in claim 1 comprising temporarily storing the converted pixel portion of the queried image object in a short term data storage device.

3. A method as claimed in claim 2 comprising erasing the converted pixel portion of the queried image object from said short term data storage device after expiration of a predetermined time or upon a manual interaction with said short term data storage device.

4. A method as claimed in claim 2 comprising transferring the converted pixel portion of the queried image object from said short term data storage device to said first long term storage device and storing the converted pixel portion of the queried image object in said first long term data storage device for a predetermined time span.

5. A method as claimed in claim 4 comprising, after reading the pixel portion of the queried image object from said second long term data storage device, erasing the pixel portion of the queried image object from said second long term data storage device.

6. A method as claimed in claim 5 comprising erasing said pixel portion of the queried image object from said second long term data storage device after expiration of a predetermined time span following readout of said pixel portion of said queried image object from said second long term data storage device.

7. A digital image information system comprising:
a first long term storage device in which pixel portions of first image objects are archived in a first image data format;
a second long term storage device in which pixel portions of second image objects are archived in a second data format, differing from said first data format;
a data bank in which text portions of said first image objects and said second image objects are stored;
an input unit in communication with said data bank that allows an image object query to be made to said data bank for a queried image object, in response to which said data bank reads the text portion of the queried image object from said data bank and, from said text portion, automatically determines whether the pixel portion of the queried image object is stored in said first long term data storage device or in said second long term data storage device;
a storage manager connected to said data bank, said storage manager, if said pixel portion of the queried image object is stored in the first long term data storage device, reading the pixel portion of the queried image object from the first long term storage device, and making the text portion and the pixel portion of the queried image object available as an output, and if said pixel portion of the queried image object is stored in said second long term data storage device, reading the pixel portion of the queried image object from the second long term data storage device; and
a conversion unit connected to said second long term memory that automatically converts said pixel portion of the queried image object from said second data format into said first data format, and makes the text portion and the converted pixel portion of the queried image object available as an output.

8. A digital information system as claimed in claim 9 comprising a short term data storage device connected to said conversion unit in which the converted pixel portion of the queried image object is temporarily stored.

9. A digital information system as claimed in claim 8 wherein said short term data storage device is connected to said storage manager and wherein said storage manager erases the converted pixel portion of the queried image object from said short term data storage device after expiration of a predetermined time or upon a manual interaction with said short term data storage device.

10. A digital information system as claimed in claim 8 wherein said short term data storage device is connected to said storage manager and wherein said storage manager transfers the converted pixel portion of the queried image object from said short term data storage device to said first long term storage device and stores the converted pixel portion of the queried image object in said first long term data storage device for a predetermined time span.

11. A digital information system as claimed in claim 10 wherein said short term data storage device is connected to said storage manager and wherein said storage manager after reading the pixel portion of the queried image object from said second long term data storage device, erases the pixel portion of the queried image object from said second long term data storage device.

12. A digital information system as claimed in claim 11 wherein said storage manager erases said pixel portion of the queried image object from said second long term data storage device after expiration of a predetermined time span following readout of said pixel portion of said queried image object from said second long term data storage device.

13. A computer-readable medium encoded with a data structure for providing image objects in a digital information system having a first long term storage device in which pixel portions of first image objects are archived in a first image data format, a second long term storage device in which pixel portions of second image objects are archived in a second image format, differing from said first image format, and a data bank, having access to each of said first and second long term storage devices, in which text portions of said first image objects and said second image objects are stored, said data structure:
upon an image object query to said data bank for a queried image object, causing said data bank to read the text portion of the queried image object from said data bank and, from said text portion, automatically determine whether the pixel portion of the queried image object is stored in said first long term data storage device or in said second long term data storage device;
if said pixel portion of the queried image object is stored in the first long term data storage device, causing the pixel portion of the queried image object to be read from the first long term storage device, and to make the text portion and the pixel portion of the queried image object available as an output; and
if said pixel portion of the queried image object is stored in said second long term data storage device, causing the pixel portion of the queried image object to be read from the second long term data storage device, and automatically causing said pixel portion of the queried image object to be converted from said second data format into said first data format, and to make the text portion and the converted pixel portion of the queried image object available as an output.
